(19) United States
(12) Patent Application Publication
(10) Pub. No.: US 2026/0109624 A1
(43) Pub. Date: Apr. 23, 2026

(54) LIQUID CIRCULATING SYSTEM

(71) Applicant: Nomura Micro Science Co., Ltd., Atsugi-Shi, Kanagawa (JP)

(72) Inventor: Takatsugu KITO, Atsugi-shi, Kanagawa (JP)

(73) Assignee: Nomura Micro Science Co., Ltd., Atsugi-Shi, Kanagawa (JP)

(21) Appl. No.: 19/159,344

(22) PCT Filed: Apr. 18, 2024
(86) PCT No.: PCT/JP2024/015402

§ 371 Date: Aug. 25, 2025

(30) Foreign Application Priority Data
Jun. 15, 2023 (JP) 2023-098744

(51) Int. Cl. C02F 1/00; C02F 1/42; C02F 1/44; C02F 103/04; C02F 103/34

(52) U.S. Cl. CPC C02F 1/008; C02F 1/42; C02F 1/444; C02F 2103/04; C02F 2103/346; C02F 2201/005; C02F 2209/03; C02F 2209/40; C02F 2301/046; C02F 2303/14; C02F 2303/16

(57) ABSTRACT

A liquid circulating system has: a circulation path having a supply pipe that supplies liquid within a tank via plural treatment sections to a point of use, and a return pipe that returns liquid from the point of use to the tank; a first pump provided at the supply pipe in the midst of the plural treatment sections; a pressure detecting section provided at the return pipe; a regulating valve provided at the return pipe at a downstream side of the pressure detecting section, and regulating pressure of an interior of the return pipe in accordance with pressure detected by the pressure detecting section; a flow rate detecting section provided at the supply pipe between the point of use and a treatment section that is furthest downstream, and detecting a flow rate of liquid at an interior of the supply pipe; and a first pump controlling section that, in accordance with the flow rate detected by the flow rate detecting section, controls the first pump such that liquid flowing in the supply pipe becomes a predetermined flow rate.

### TECHNICAL FIELD

The present disclosure relates to liquid circulating system.

### BACKGROUND ART

Devices that prepare pure water are conventionally known.

Japanese Patent Application Laid-Open (JP-A) No. 2023-8823 discloses a pure water preparing device having a pump that causes pure water within a tank to flow through a circulation line, and a water feed line that branches-off from the circulation line at the downstream side of the pump and is connected to a point of use. This pure water preparing device is provided with control means that switches the rotational frequency of the pump on the basis of results of sensing whether or not there is flowing of pure water to the water feed line or sensing changes in the flow rate of the pure water flowing through the water feed line.

Japanese U.S. Pat. No. 7,011,958 discloses a liquid supplying device having a pump supplying a liquid within a tank to a point of use, a pipe that returns, to the tank, liquid that is being returned from the point of use, a pressure meter measuring the return pressure within the pipe, and a flowmeter measuring the return flow rate within the pipe. This liquid supplying device is provided with a control section that, on the basis of the return pressure and the return flow rate, controls a pressure regulating means for regulating the return pressure. On the basis of the return flow rate, the control section decides on a target value of the return pressure, and controls the pressure regulating means such that the return pressure becomes the target value.

### SUMMARY OF INVENTION

### Technical Problem

The amount of ultrapure water that is used at the point of use changes depending on the running situations of devices for fabricating semiconductors or the like that are set at the point of use. Further, in devices for fabricating semiconductors or the like, ultrapure water of a substantially constant pressure is always required, and, if fluctuations in pressure arise, there is the concern that the yield of the semiconductors or the like that are being fabricated will be affected. Accordingly, in an ultrapure water producing device, there is the need to always supply liquid at a substantially constant pressure even if the flow rate varies.

In particular, in the case of ultrapure water producing devices whose treatment flow rate is 50 m³/h or greater, there are often cases in which the scale of the ultrapure water producing device itself is large, and plural ultrapure water producing devices are set in parallel. Moreover, because the scale of the point of use, i.e., a factory, is large, the distance of the supply pipe from the final end (e.g., UF) of the ultrapure water producing device to the point of use is long. At the same time, the return pipe also is long, and the pressure losses in the supply pipe and the return pipe are great.

The pure water producing device described in JP-A No. 2023-8823 has the water feed line that branches-off from the circulation line at the downstream side of the pump and is connected to the point of use. Therefore, in a device having a circulation path that returns to a tank the pure water that has passed through the point of use, the structure of the pure water preparing device described in JP-A No. 2023-8823 cannot be used, and there is room for improvement. Further, because there usually are plural water feed lines to the point of use, the flow rate must be measured accurately at each of them, and a large number of flowmeters are required. If the number of measuring devices increases, the number of sources of deterioration in water quality increases.

Further, in the liquid supplying device described in Japanese U.S. Pat. No. 7,011,958, a target value of the return pressure is decided upon on the basis of the return flow rate, and the pressure regulating means is controlled such that the return pressure becomes the target value. In a structure that controls the rotational frequency of a pump on the basis of the pressure within a supply pipe that supplies a liquid to a point of use for example, if the target value of the return pressure changes at the time of controlling the pressure regulating means, the flow rate of the liquid supplied to the point of use will change, and there is the possibility that the water quality will deteriorate. Further, because the control system is complex, there is difficulty in practical use as well.

The present disclosure was made in view of the above-described problematic points, and an object thereof is to provide a liquid circulating system that can suppress fluctuations in the flow rate of a liquid supplied to a point of use, regardless of whether or not the liquid is being used at the point of use.

### Solution to Problem

As a result of carrying out earnest studies, the present inventors arrived at the technique of the present disclosure by discovering that fluctuations in the flow rate at a supply pipe from the final end of an ultrapure water device to a point of use, and at a return pipe, are a cause of fluctuations in pressure at the point of use.

A liquid circulating system of a first aspect has: a tank storing a liquid; plural treatment sections carrying out respectively different treatments on liquid supplied from the tank; a circulation path having a supply pipe that supplies liquid within the tank via the plural treatment sections to a point of use that is a supply destination, and a return pipe that returns liquid from the point of use to the tank; a first pump provided at the supply pipe in the midst of the plural treatment sections, and supplying liquid toward the point of use; a first pressure detecting section provided at the return pipe, and detecting pressure of an interior of the return pipe; a regulating valve provided at the return pipe at a downstream side of the first pressure detecting section, and regulating pressure of the interior of the return pipe in accordance with the pressure detected by the first pressure detecting section; a flow rate detecting section provided at the supply pipe between the point of use and a treatment section that is furthest downstream among the plural treatment sections, and detecting a flow rate of liquid at an interior of the supply pipe; and a first pump controlling section that, in accordance with the flow rate detected by the flow rate detecting section, controls the first pump such that liquid flowing in the supply pipe becomes a predetermined flow rate.

In accordance with the liquid circulating system of the first aspect, the circulation path of the liquid, which has the supply pipe and the return pipe, is provided, and liquid within the tank is supplied by the supply pipe via the plural treatment sections to the point of use that is the supply destination. At the plural treatment sections, respectively different treatments are carried out on the liquid supplied from the tank. Moreover, liquid is returned from the point of use to the tank by the return pipe. The liquid is thereby circulated through the circulation path.

The first pressure detecting section is provided at the return pipe, and the pressure of the interior of the return pipe is detected by the first pressure detecting section. The regulating valve is provided at the return pipe at the downstream side of the first pressure detecting section. The pressure of the interior of the return pipe is regulated by the regulating valve in accordance with the pressure detected by the first pressure detecting section.

Moreover, the flow rate detecting section is provided at the supply pipe between the point of use and the treatment section that is furthest downstream among the plural treatment sections. The flow rate of the liquid at the interior of the supply pipe is detected by the flow rate detecting section. Further, in accordance with the flow rate detected by the flow rate detecting section, the first pump is controlled by the first pump controlling section such that the liquid flowing in the supply pipe becomes a predetermined flow rate. Due thereto, fluctuations in the flow rate at which the liquid is supplied from the flow rate detecting section to the point of use are suppressed. Therefore, fluctuations in the flow rate of the liquid supplied to the point of use can be suppressed regardless of whether or not the liquid is being used at the point of use. Further, because fluctuations in the flow rate are small, a deterioration in the water quality of the ultrapure water due to fluctuations in the flow rate is kept to a minimum.

In a liquid circulating system of a second aspect, the liquid circulating system of the first aspect has: a second pump provided at the supply pipe at a downstream side of the tank, and supplying liquid within the tank toward the plural treatment sections; a second pressure detecting section provided at the supply pipe at an upstream side of the first pump, and detecting pressure of the interior of the supply pipe; and a second pump controlling section that, in accordance with the pressure detected by the second pressure detecting section, controls the second pump such that the pressure of the interior of the supply pipe becomes a predetermined pressure.

In accordance with the liquid circulating system of the second aspect, the second pump is provided at the supply pipe at the downstream side of the tank, and liquid within the tank is supplied by the second pump toward the plural treatment sections. The second pressure detecting section is provided at the supply pipe at the upstream side of the first pump, and the pressure of the interior of the supply pipe is detected by the second pressure detecting section. The second pump is controlled by the second pump controlling section in accordance with the pressure detected by the second pressure detecting section, such that the pressure at the interior of the supply pipe becomes a predetermined pressure. Therefore, at the time of supplying liquid in the tank through the supply pipe toward the plural treatment sections by the second pump, fluctuations in the pressure of the interior of the supply pipe at the position of the second pressure detecting section can be suppressed.

In a liquid circulating system of a third aspect, in the liquid circulating system of the first aspect, the first pressure detecting section is provided at a place that, from a final stage of a junction with the point of use at the return pipe, is less than 20% of a length of the return pipe between the final stage and the tank.

In accordance with the liquid circulating system of the third aspect, the first pressure detecting section is provided at a place that, from a final stage of a junction with the point of use at the return pipe, is less than 20% of the length of the return pipe between the final stage and the tank. For example, in a structure in which, in a case in which the length of the return pipe between the tank and the point of use is long, the first pressure detecting section is provided at a place that is, from the final stage of a junction with the point of use at the return pipe, 20% or more of the length of the return pipe between that final stage and the tank, when usage of the liquid starts at the point of use, if the opening diameter of the return pipe is the same, the flow rate of the liquid in the return pipe decreases, and the pressure loss decreases. Accordingly, at the first pressure detecting section that is provided at a place that, from the final stage of a junction with the point of use, is 20% or more of the length of the return pipe, there is the possibility that the pressure of the interior of the return pipe will not be regulated appropriately by the regulating valve.

In contrast, if the first pressure detecting section is provided at a place that, from the final stage of a junction with the point of use at the return pipe, is less than 20% of the length of the return pipe, even if the flow rate of the liquid of the return pipe decreases, the decrease in the pressure loss can be ignored. Therefore, the pressure of the interior of the return pipe can be regulated appropriately by the regulating valve in accordance with the pressure detected by the first pressure detecting section.

In a liquid circulating system of a fourth aspect, in the liquid circulating system of the first aspect, the first pressure detecting section is provided at the return pipe at a side nearer to a final stage of a junction with the point of use than the tank, and at a place at which, when comparing a differential pressure of times when a flow rate of liquid in the return pipe is a maximum and a minimum, the differential pressure is less than or equal to 9.8 kPa.

In accordance with the liquid circulating system of the fourth aspect, the first pressure detecting section is provided at the return pipe at a side nearer to the final stage of a junction with the point of use than the tank, at a place at which the differential pressure of times when the flow rate of the liquid in the return pipe is a maximum and a minimum is less than or equal to 9.8 kPa. For example, in a structure in which, in a case in which the length of the return pipe between the tank and the point of use is long, the first pressure detecting section is provided at the return pipe at a side nearer to the tank than the final stage of a junction with the point of use, and at a place at which the differential pressure of the times when the flow rate of the liquid in the return pipe is a maximum and a minimum is greater than 9.8 kPa, when usage of the liquid starts at the point of use, if the opening diameter of the return pipe is the same, the flow rate of the liquid in the return pipe decreases, and the pressure loss decreases. Accordingly, at the first pressure detecting section that is provided at a position near the tank, there is the possibility that the pressure of the interior of the return pipe will not be regulated appropriately by the regulating valve.

In contrast, if the first pressure detecting section is provided at the return pipe at a side nearer to the final stage of a junction with the point of use than the tank and at a place at which the differential pressure of times when the flow rate of the liquid in the return pipe is a maximum and a minimum is less than or equal to 9.8 kPa, even if the flow rate of the liquid of the return pipe decreases, it is difficult to be affected by the decrease in the pressure loss. Therefore, the pressure of the interior of the return pipe can be regulated appropriately by the regulating valve in accordance with the pressure detected by the first pressure detecting section.

In a liquid circulating system of a fifth aspect, in the liquid circulating system of the first aspect, the first pump is a booster pump that supplies liquid by applying an insufficient amount of pressure of the supply pipe.

In accordance with the liquid circulating system of the fifth aspect, the first pump, which is provided at the supply pipe in the midst of the plural treatment sections, is a booster pump that supplies the liquid by applying the insufficient amount of pressure of the supply pipe. Due thereto, it is easy to control the flow rate of the liquid at the exit side of the booster pump in accordance with the flow rate of the liquid at the interior of the supply pipe detected by the flow rate detecting section that is at the supply pipe between the point of use and the treatment section that is furthest downstream among the plural treatment sections. Therefore, fluctuations in the flow rate of the liquid supplied to the point of use can be suppressed more reliably.

In a liquid circulating system of a sixth aspect, in the liquid circulating system of the first aspect, the plural treatment sections include: a filtration device structuring the treatment section that is furthest downstream, and having an ultrafiltration membrane; and an ion exchanger provided at an upstream side of and immediately before the filtration device, and having an ion exchange resin, and the ion exchanger has two or more ion exchange resin treatment sections that are connected in parallel to the supply pipe, and to and from which liquid is introduced and discharged respectively.

In accordance with the liquid circulating system of the sixth aspect, the ion exchanger has two or more ion exchange resin treatment sections that are connected in parallel to the supply pipe. The liquid is introduced respectively into the two or more ion exchange resin treatment sections, and the liquid treated by the respective ion exchange resins is discharged. Due thereto, one of the two or more ion exchange resin treatment sections can be stopped and maintenance carried out thereon, and liquid can be made to pass through another of the ion exchange resin treatment sections. Therefore, maintenance of one of the two or more ion exchange resin treatment sections can be carried out while operation of the liquid circulating system is continued as is.

In a liquid circulating system of a seventh aspect, the liquid circulating system of the sixth aspect is structured such that, at a time of maintenance of the ion exchanger, one of the ion exchange resin treatment sections is stopped, and liquid that has passed through another of the ion exchange resin treatment sections is supplied to the filtration device.

In accordance with the liquid circulating system of the seventh aspect, at the time of maintenance of the ion exchanger, one of the ion exchange resin treatment sections is stopped, and liquid that has passed through another of the ion exchange resin treatment sections is supplied to the filtration device.

For example, in a structure in which the first pump is controlled in accordance with the pressure of the interior of the supply pipe detected by a pressure meter provided at the supply pipe between the point of use and the treatment section that is the furthest downstream, in a case in which changing of the usage amount of the liquid at the point of use and stoppage of one of the ion exchange resin treatment sections are carried out simultaneously, control of the first pump in accordance with the pressure meter and control of the regulating valve in accordance with first pressure detecting section must be carried out. At this time, because there are two types of pressure control, the flow rate and the pressure of the liquid cannot be predicted. Depending on the timing, there is the possibility that the operating flow rate of the liquid will change, and that it will not be possible to return the operating flow rate to its original state (e.g., there is the possibility that the operating flow rate of the liquid in the liquid circulating system will become unstable).

In contrast, in the above-described liquid circulating system, in a case in which changing of the usage amount of the liquid at the point of use and stoppage of one of the ion exchange resin treatment sections are carried out simultaneously, the first pump is controlled in accordance with the flow rate of the liquid detected by the flow rate detecting section that is at the supply pipe between the point of use and the treatment section that is the furthest downstream. Therefore, because there are control of the first pump in accordance with the flow rate detecting section and control of the regulating valve in accordance with the first pressure detecting section, the operating flow rate of the liquid in the liquid circulating system can be stabilized.

In a liquid circulating system of an eighth aspect, the liquid circulating system of the sixth aspect is structured such that, at a time of maintenance of the ion exchanger, liquid is introduced into one of the ion exchange resin treatment sections and washes the ion exchange resin, and liquid that has been used in washing is discharged to a discharge path that is other than the supply pipe, and liquid is introduced into another of the ion exchange resin treatment sections, and liquid that has passed through the other of the ion exchange resin treatment sections is supplied to the filtration device.

In accordance with the liquid circulating system of the eighth aspect, at a time of maintenance of the ion exchanger, liquid is introduced into one of the ion exchange resin treatment sections and washes the ion exchange resin, and the liquid that has been used in washing is discharged to a discharge path, and the liquid that has passed through another of the ion exchange resin treatment sections is supplied to the filtration device.

For example, in a structure in which the first pump is controlled in accordance with the pressure of the interior of the supply pipe detected by a pressure meter provided at the supply pipe between the point of use and the treatment section that is the furthest downstream, in a case in which changing of the usage amount of the liquid at the point of use and washing of the ion exchange resin of one of the ion exchange resin treatment sections are carried out simultaneously, control of the first pump accordance with the pressure meter and control of the regulating valve in accordance with first pressure detecting section must be carried out. At this time, because there are two types of pressure control, the flow rate and the pressure of the liquid cannot be predicted. Depending on the timing, there is the possibility that the operating flow rate of the liquid will change, and that it will not be possible to return the operating flow rate to its original state (e.g., there is the possibility that the operating flow rate of the liquid in the liquid circulating system will become unstable).

In contrast, in the above-described liquid circulating system, in a case in which changing of the usage amount of the liquid at the point of use and washing of the ion exchange resin of one of the ion exchange resin treatment sections are carried out simultaneously, the first pump is controlled in accordance with the flow rate of the liquid detected by the flow rate detecting section that is at the supply pipe between the point of use and the treatment section that is the furthest downstream. Therefore, because there are control of the first pump in accordance with the flow rate detecting section and control of the regulating valve in accordance with the first pressure detecting section, the operating flow rate of the liquid in the liquid circulating system can be stabilized.

### Advantageous Effects of Invention

In accordance with the liquid circulating system of the present disclosure, fluctuations in the flow rate of a liquid supplied to a point of use can be suppressed regardless of whether or not the liquid is being used at the point of use.

The technique of the present disclosure can be applied broadly to liquid supplying devices and liquid supplying systems having a circulating route, and can suitably be applied to ultrapure water producing devices and ultrapure water producing systems. In particular, the technique of the present disclosure can be even more suitably applied to ultrapure water producing devices and ultrapure water producing systems in which the supply rate is 50 m³/h or more, and/or to plural ultrapure water producing devices and ultrapure water producing systems that are provided in parallel.

### BRIEF DESCRIPTION OF DRAWINGS

FIG. 1 is a structural drawing illustrating a liquid circulating system of a first embodiment.

FIG. 2 is a structural drawing illustrating a second ion exchanger, an ultrafiltration membrane and a point of use of the liquid circulating system of the first embodiment.

FIG. 3 is a block drawing illustrating hardware structures of the liquid circulating system of the first embodiment.

FIG. 4 is a structural drawing illustrating the second ion exchanger, the ultrafiltration membrane and the point of use of the liquid circulating system of the first embodiment, and is a drawing illustrating a state in which liquid is being used at the point of use.

FIG. 5 is a structural drawing illustrating the second ion exchanger, the ultrafiltration membrane and the point of use of the liquid circulating system of the first embodiment, and is a drawing illustrating a state in which a first ion exchange resin treatment section is stopped.

FIG. 6 is a structural drawing illustrating the second ion exchanger, the ultrafiltration membrane and the point of use of the liquid circulating system of the first embodiment, and is a drawing illustrating a state in which resin washing of the first ion exchange resin treatment section is being carried out.

FIG. 7 is a structural drawing illustrating a liquid circulating system of a first comparative example.

FIG. 8 is a structural drawing illustrating the second ion exchanger, the ultrafiltration membrane and the point of use of the liquid circulating system of the first comparative example.

FIG. 9 is a structural drawing illustrating the second ion exchanger, the ultrafiltration membrane and the point of use of the liquid circulating system of the first comparative example, and is a drawing illustrating a state in which liquid is being used at the point of use.

FIG. 10 is a structural drawing illustrating the second ion exchanger, the ultrafiltration membrane and the point of use of a liquid circulating system of a second comparative example, and is a drawing illustrating a state in which liquid is being used at the point of use.

FIG. 11 is a structural drawing illustrating the second ion exchanger, the ultrafiltration membrane and the point of use of the liquid circulating system of the first comparative example, and is a drawing illustrating a state in which liquid is not being used at the point of use, and the first ion exchange resin treatment section is stopped.

FIG. 12 is a structural drawing illustrating the second ion exchanger, the ultrafiltration membrane and the point of use of the liquid circulating system of the first comparative example, and is a drawing illustrating a state in which the liquid is being used at the point of use, and the first ion exchange resin treatment section is stopped.

FIG. 13 is a structural drawing illustrating the second ion exchanger, the ultrafiltration membrane and the point of use of the liquid circulating system of the first comparative example, and is a drawing illustrating a state in which liquid is not being used at the point of use, and resin washing of the first ion exchange resin treatment section is being carried out.

FIG. 14 is a structural drawing illustrating the second ion exchanger, the ultrafiltration membrane and the point of use of the liquid circulating system of the first comparative example, and is a drawing illustrating a state in which the liquid is being used at the point of use, and resin washing of the first ion exchange resin treatment section is being carried out.

### DESCRIPTION OF EMBODIMENTS

An embodiment of the present disclosure is described hereinafter on the basis of the drawings. Illustration of structures having little relevance to the present disclosure is omitted in the respective drawings.

### Overall Structure of Liquid Circulating System

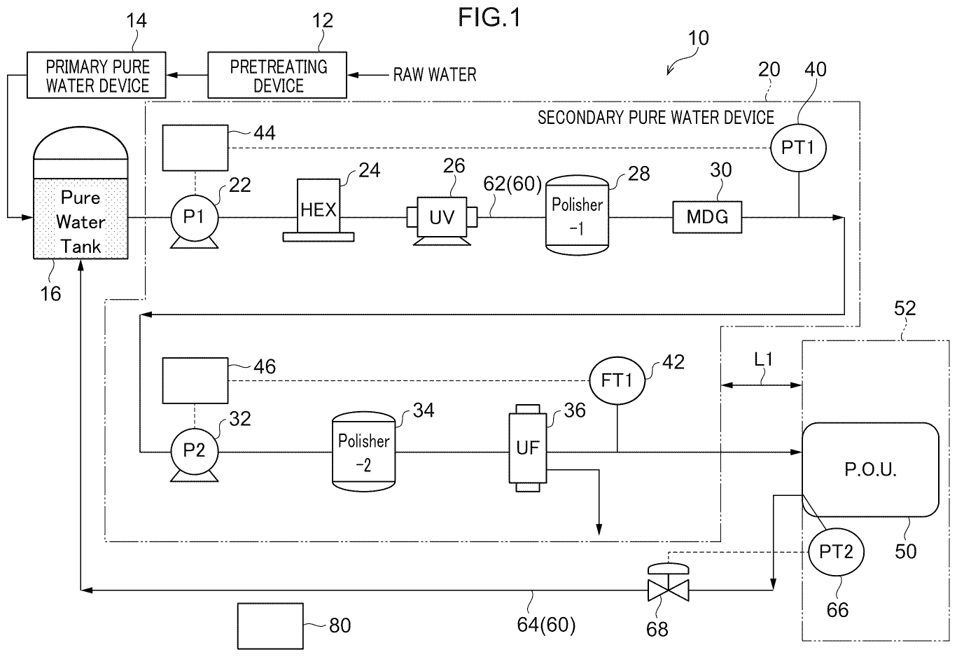

The overall structure of a liquid circulating system of a first embodiment is illustrated in FIG. 1. An example is described in which, in the liquid circulating system of the first embodiment, pure water that serves as an example of a liquid is supplied and recovered.

As illustrated in FIG. 1, a liquid circulating system 10 has a pretreating device 12, a primary pure water device 14, a pure water tank 16, a secondary pure water device 20, and a point of use 50. The secondary pure water device 20 has a circulating pump (i.e., P1) 22, a heat exchanger (i.e., HEX) 24, an ultraviolet light irradiating device (i.e., UV) 26, a first ion exchanger (i.e., polisher-1) 28, a membrane degasification device (i.e., MDG) 30, a booster pump (i.e., P2) 32, a second ion exchanger (i.e., polisher-2) 34, and an ultrafiltration device (i.e., UF) 36.

Further, the liquid circulating system 10 has a supply pipe 62 that supplies liquid within the pure water tank 16 (in the first embodiment, primary pure water that is described later) via the secondary pure water device 20 to the point of use 50 that is the supply destination, and a return pipe 64 that returns liquid from the point of use 50 to the pure water tank 16. In the liquid circulating system 10, a circulation path 60 that circulates the liquid of the pure water tank 16 is structured by the supply pipe 62 and the return pipe 64. The heat exchanger 24, the ultraviolet light irradiating device 26, the first ion exchanger 28, the membrane degasification device 30, the second ion exchanger 34 and the ultrafiltration device 36 that are within the secondary pure water device 20 are an example of the plural treatment sections that carry out respectively different treatments on the liquid.

The liquid circulating system 10 has a control device 80 that controls the respective sections of the liquid circulating system 10. Note that, although the one control device 80 is illustrated in FIG. 1, the control device 80 may be structured by plural control sections that are located at separate places.

The liquid circulating system 10 has a pressure detector (i.e., PT1) 40 provided at the supply pipe 62 between the membrane degasification device 30 and the second ion exchanger 34, and a flow rate detector (i.e., FT1) 42 provided at the supply pipe 62 between the point of use 50 and the ultrafiltration device 36 that is the furthest downstream. Further, the liquid circulating system 10 has a pressure detector (i.e., PT2) 66 provided at the return pipe 64, and a regulating valve 68 provided at the return pipe 64 at the downstream side of the pressure detector 66.

### Pretreating Device

Raw water is supplied to the pretreating device 12. The pretreating device 12 removes turbidity from the supplied raw water by using a flocculation and sedimentation means, sand filtration means, membrane filtration means or the like, and obtains pretreated water from which some of the suspended matter and organic matter have been removed. Examples of raw water are industrial water, tap water, groundwater and river water.

### Primary Pure Water Device

The primary pure water device 14 further carries out a purification treatment on the pretreated water obtained by treatment at the pretreating device 12, and removes impurities from the pretreated water and obtains primary pure water. Specifically, the primary pure water device 14 has respective devices such as a demineralizing device that removes impurity ions, a reverse osmosis membrane device that removes inorganic ions, organic matter, minute particles and the like, a vacuum degassing device or membrane degassing device that removes dissolved gasses such as dissolved oxygen, and a regenerative mixed bed demineralizing device or electric regenerative demineralizing device that removes remaining ions and the like.

### Pure Water Tank

The primary pure water obtained at the primary pure water device 14 is fed to the pure water tank 16. The pure water tank 16 is an example of the tank. The pure water tank 16 is a container that temporarily stores the primary pure water obtained at the primary pure water device 14. The material, the shape and the like of the pure water tank 16 are not particularly limited provided that it can stably store the primary pure water without the elution of components from the container and the generation of rust. For example, materials such as fiber reinforced plastics (FRP), polyethylene, SUS 304, SUS 316, and materials in which these are lined by a fluorine resin such as polytetrafluoroethylene are preferably used. Further, it is preferable that the upper portion of the pure water tank 16 be purged by pure nitrogen in order to prevent the absorption of impurity gasses such as carbon dioxide gas and oxygen.

As described later, at the time of circulating and recovering, of the ultrapure water that is produced, the ultrapure water that is not used at the point of use 50, the pure water tank 16 mixes and stores this water with the above-described primary pure water. This mixed water of the primary pure water stored in the pure water tank 16 and the ultrapure water that is returned from the point of use also is called “primary pure water” hereinafter.

### Secondary Pure Water Device

As illustrated in FIG. 1, at the secondary pure water device 20, primary pure water is supplied from the pure water tank 16 toward the heat exchanger 24 by the circulating pump 22 provided at the supply pipe 62 at the downstream side of the pure water tank 16. The circulating pump 22 is an example of the second pump. A power source 44 is connected to the circulating pump 22.

Further, at the secondary pure water device 20, the ultrapure water produced by the secondary pure water device 20 is supplied toward the point of use 50 by the booster pump 32 provided at the supply pipe 62 between the membrane degasification device 30 and the second ion exchanger 34. The booster pump 32 is a pump that supplies the primary pure water by applying the insufficient amount of pressure of the supply pipe 62. The booster pump 32 is an example of the first pump. A power source 46 is connected to the booster pump 32.

At the heat exchanger 24 of the secondary pure water device 20, the temperature of the primary pure water is adjusted by heat exchange (e.g., heating or cooling) with respect to the primary pure water. For example, a plate-type heat exchanger can be given as an example of the heat exchanger 24, but the specific structure thereof is not particularly limited.

The primary pure water whose temperature has been adjusted by the heat exchanger 24 is fed to the ultraviolet light irradiating device 26. At the ultraviolet light irradiating device 26, decomposing of organic matter and sterilization of live bacteria that are within the primary pure water are carried out by ultraviolet light being irradiated onto the primary pure water. Provided that the ultraviolet light irradiating device 26 has, for example, an ultraviolet lamp that can irradiate wavelengths in the vicinity of 185 nm or wavelengths in the vicinity of 254 nm, the ultraviolet light irradiating device 26 can reliably carry out decomposing of organic matter and sterilization of live bacteria that are within the primary pure water. The ultraviolet lamp that is used is not particularly limited, but a low-pressure mercury lamp is preferable from the standpoint of ease of handling.

The first ion exchanger 28 is a device that, by an ion exchange resin, removes impurity ions such as hydrogen peroxide and organic acids that are generated by the ultraviolet light irradiating device 26. For example, anionic resins or mixed bed resins, in which an anionic resin and a cationic resin are mixed together, are used as the ion exchange resin. The first ion exchanger 28 is a structure in which the ion exchange resin is filled into a cylindrical, airtight container for example.

The membrane degasification device 30 is a device that removes gasses, and dissolved oxygen in particular, that are in the primary pure water by using a gas permeation membrane through which moisture does not permeate but gasses permeate. The primary pure water that has been treated by the membrane degasification device 30 is in a state in which the concentration of dissolved oxygen therein is low. The primary pure water, whose dissolved oxygen concentration has been reduced by the membrane degasification device 30, is fed to the second ion exchanger 34 by the booster pump 32.

In the same way as the first ion exchanger 28, the second ion exchanger 34 is a device that removes impurity ions such as organic acids by an ion exchange resin. For example, anionic resins or mixed bed resins, in which an anionic resin and a cationic resin are mixed together, are used as the ion exchange resin. Note that, although the first ion exchanger 28 is provided at the secondary pure water device 20, the secondary pure water device 20 may be structured such that the first ion exchanger 28 is not provided thereat, and only the second ion exchanger 34 is provided. The primary pure water, at which impurity ions have been removed by the second ion exchanger 34, is fed to the ultrafiltration device 36. The structure of the second ion exchanger 34 is described later.

The ultrafiltration device 36 has an ultrafiltration membrane, and is a device that removes minute particles by the ultrafiltration membrane and produces ultrapure water. The ultrafiltration device 36 is an example of the filtering device. The ultrafiltration device 36 is disposed at the final end in the supplying direction of the supply pipe 62 within the secondary pure water device 20, and structures the treatment section that is the furthest downstream within the secondary pure water device 20. The ultrapure water obtained by the secondary pure water device 20 is supplied by the supply pipe 62 to the point of use 50 that is the place of usage. The structure of the ultrafiltration device 36 is described later. Note that, in the present disclosure, the exit side of the ultrafiltration device is the final end of the ultrapure water device.

Note that an oxidant removing device provided with a catalyst resin carrying Pt or Pd metal, or a reductive resin carrying a sulfite group, a hydrogen sulfite group or a nitrite group, and a boron-selective ion exchanger, can also be set in the secondary pure water device 20. Further, the resins of these devices can also be filled within the first ion exchanger or the second ion exchanger.

The pressure detector 40 detects the pressure at the interior of the supply pipe 62, between the membrane degasification device 30 and the booster pump 32. The pressure detector 40 is an example of the second pressure detecting section. A pressure transmitter for example is used as the pressure detector 40. A pressure transmitter is a communication device that converts pressure data into signals and emits the signals as radio waves. In accordance with the pressure detected by the pressure detector 40, the control device 80 controls the circulating pump 22 such that the pressure of the interior of the supply pipe 62 becomes a predetermined pressure. Control of the circulating pump 22 is described later.

The flow rate detector 42 detects the flow rate of the ultrapure water at the interior of the supply pipe 62, between the ultrafiltration device 36, which is the furthest downstream within the secondary pure water device 20, and the point of use 50. The flow rate detector 42 is an example of the flow path detecting section. A flow rate transmitter for example is used as the flow rate detector 42. A flow rate transmitter is a communication device that converts flow rate data into signals and emits the signals as radio waves. In accordance with the flow rate detected by the flow rate detector 42, the control device 80 controls the booster pump 32 such that the ultrapure water flowing through the supply pipe 62 becomes a predetermined flow rate. Control of the booster pump 32 is described later.

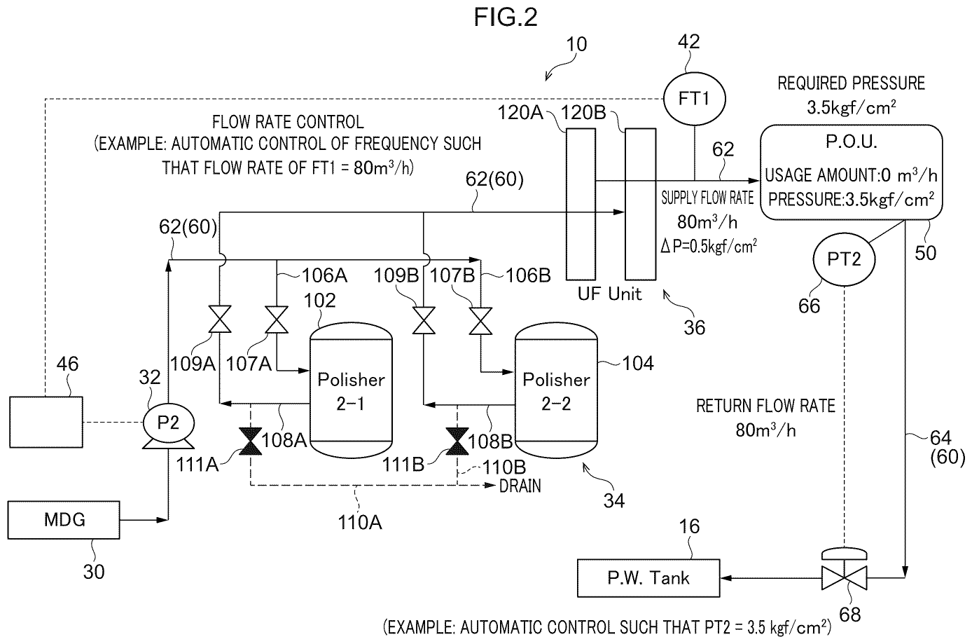

Structures in the vicinity of the second ion exchanger 34, the ultrafiltration device 36 and the point of use 50 are illustrated in FIG. 2. As illustrated in FIG. 2, the second ion exchanger 34 has a first ion exchange resin treatment section (i.e., polisher 2-1) 102 and a second ion exchange resin treatment section (i.e., polisher 2-2) 104 that are connected in parallel to the supply pipe 62. Specifically, the supply pipe 62 is branched into two introducing pipes 106A, 106B. The introducing pipe 106A is connected to the first ion exchange resin treatment section 102, and the introducing pipe 106B is connected to the second ion exchange resin treatment section 104. Due thereto, primary pure water is introduced from the supply pipe 62 via the introducing pipes 106A, 106B to the first ion exchange resin treatment section 102, the second ion exchange resin treatment section 104, respectively. Valves 107A, 107B that open and close the respective flow paths are provided at the introducing pipes 106A, 106B.

A discharge pipe 108A is connected to the first ion exchange resin treatment section 102, and a discharge pipe 108B is connected to the second ion exchange resin treatment section 104. The discharge pipe 108A and the discharge pipe 108B merge with the supply pipe 62 at the downstream side thereof. Valves 109A, 109B that open and close the respective flow paths are provided at the discharge pipes 108A, 108B.

Discharge paths 110A, 110B are connected to mid-sections of the discharge pipes 108A, 108B, respectively. Valves 111A, 111B that open and close the respective flow paths are provided at the discharge paths 110A, 110B. At usual times of usage of the secondary pure water device 20, the valves 111A, 111B are closed (see FIG. 2). Due thereto, the primary pure water that has been treated at the first ion exchange resin treatment section 102 is supplied via the discharge pipe 108A to the supply pipe 62, and the primary pure water that has been treated at the second ion exchange resin treatment section 104 is supplied via the discharge pipe 108B to the supply pipe 62.

Note that, although the two ion exchange resin treatment sections that are the first ion exchange resin treatment section 102 and the second ion exchange resin treatment section 104 are provided at the second ion exchanger 34, the second ion exchanger 34 instead may be a structure that is provided with three or more ion exchange resin treatment sections.

As illustrated in FIG. 2, the ultrafiltration device 36 is structured as a unit having two ultrafiltration membrane treatment sections 120A, 120B. The primary pure water that has been treated by the second ion exchanger 34 is introduced via the supply pipe 62 into the two ultrafiltration membrane treatment sections 120A, 120B, and is filtered by ultrafiltration membranes. The ultrapure water that has been filtered by the two ultrafiltration membrane treatment sections 120A, 120B is supplied by the supply pipe 62 to the point of use 50.

### Point of Use

As illustrated in FIG. 1 and FIG. 2, the ultrapure water that has been supplied is used at the point of use 50. Of the ultrapure water that is supplied to the point of use 50, the ultrapure water that is not used is circulated to and recovered at the pure water tank 16 via the return pipe 64, and is stored within the pure water tank 16 together with the primary pure water. Further, in a case in which ultrapure water is not used at the point of use 50, the ultrapure water that is supplied from the secondary pure water device 20 to the point of use 50 is returned as is via the return pipe 64 to the pure water tank 16 (see FIG. 2).

As an example, the point of use 50 is provided in a clean room 52 (see FIG. 1) that is disposed at a place separated from the secondary pure water device 20. The supply pipe 62 from the downstream-most end of the secondary pure water device 20 to the portion connected to the point of use 50, and the return pipe 64 from the junction with the point of use 50 to the pure water tank 16, structure relatively long flow paths. Length L1 (see FIG. 1) of the supply pipe 62 from the downstream side end portion of a secondary pure water device 302 to the portion connected to the point of use 50 is, for example, 0.1 km or more and 1.5 km or less. Further, the length of the return pipe 64 from the junction with the point of use 50 at the return pipe 64 to the pure water tank 16 is, for example, 0.1 km or more and 1.5 km or less.

The materials of the supply pipe 62 and the return pipe 64 are not particularly limited, and PVDF (i.e., polyvinylidene fluoride), PVC (i.e., polyvinyl chloride) or stainless steel such as SUS 304 or SUS 316 can be used. However, in a case in which the liquid is ultrapure water, it is preferable to use PVDF.

The pressure detector 66 is provided at the return pipe 64 that is connected to the point of use 50, and detects the pressure of the interior of the return pipe 64. The pressure detector 66 is an example of the first pressure detecting section. A pressure transmitter for example is used as the pressure detector 66. The regulating valve 68, which is provided at the return pipe 64 at the downstream side of the pressure detector 66, regulates the pressure of the interior of the return pipe 64.

The pressure detector 66 is preferably provided at a position that, from the junction with the point of use 50 at the return pipe 64, is less than 20% of the length of the return pipe 64 between this junction and the pure water tank 16, and is more preferably provided at a position that is less than 10% of the length of the return pipe 64, and is even more preferably provided at a position that is less than 5% of the length of the return pipe 64. Here, the length of the return pipe 64 is the length from the junction with the point of use 50 at the return pipe 64 to the portion connected to the pure water tank 16.

Note that, although not illustrated, in the liquid circulating system 10, plural junction points to the point of use 50 may be provided at the circulation path 60. In this case, it is preferable to provide the pressure detector 66 at a position that, from the final stage of a junction with the point of use 50 at the return pipe 64, is less than 20% of the length of the return pipe 64 between that final stage and the pure water tank 16.

### Hardware Structures of Liquid Circulating System

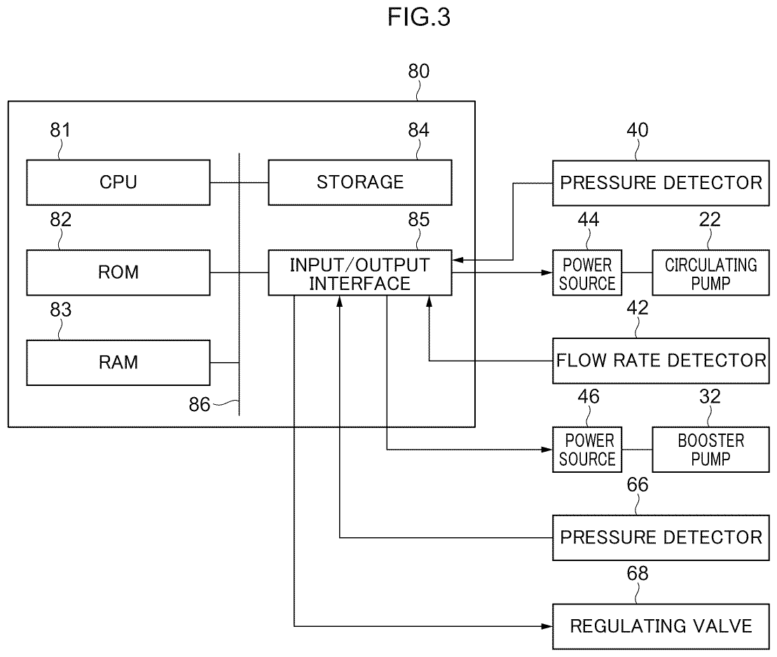

FIG. 3 is a block drawing of hardware structures of the liquid circulating system 10. As illustrated in FIG. 3, the control device 80 has respective structures that are a CPU (i.e., Central Processing Unit) 81, a ROM (i.e., Read Only Memory) 82, a RAM (i.e., Random Access Memory) 83, a storage 84 and an input/output interface 85. These respective structures are connected to one another via bus 86.

The CPU 81 is a central computing processing unit, and executes various programs and controls respective sections. Namely, the CPU 81 reads-out a program from the ROM 82 or the storage 84, and executes the program by using the RAM 83 as a workspace. The CPU 81 carries out control of the above-described respective structures, and various computing processings, in accordance with programs recorded in the ROM 82 or the storage 84. In the first embodiment, a liquid circulating processing program is stored in the ROM 82 or the storage 84.

The ROM 82 stores various programs and various data. The RAM 83 temporarily stores programs and data as a workspace. The storage 84 is structured by an HDD (i.e., a Hard Disk Drive) or an SSD (i.e., Solid State Drive), and stores various programs, including the operating system, and various data.

The pressure detector 40, the flow rate detector 42, the pressure detector 66 and the regulating valve 68 are connected to the input/output interface 85. Further, the circulating pump 22 is connected via the power source 44 to the input/output interface 85, and the booster pump 32 is connected via the power source 46 to the input/output interface 85.

The value of the pressure detected by the pressure detector 40 of the supply pipe 62 is inputted to the control device 80. In accordance with the pressure detected by the pressure detector 40, the control device 80 controls the frequency of the electricity supplied from the power source 44 to the circulating pump 22. The pressure and the flow rate at the exit of the circulating pump 22 are thereby regulated. The control device 80 is an example of the second pump controlling section. The control device 80 controls the frequency of the electricity supplied from the power source 44 to the circulating pump 22 such that the pressure of the pressure detector 40 becomes a preset pressure.

The value of the flow rate of the ultrapure water detected by the flow rate detector 42 of the supply pipe 62 is inputted to the control device 80. In accordance with the flow rate of the ultrapure water detected by the flow rate detector 42, the control device 80 controls the frequency of electricity supplied from the power source 46 to the booster pump 32. The booster pump 32 is a pump that supplies the primary pure water by applying the insufficient amount of pressure of the supply pipe 62. The pressure and the flow rate at the exit of the booster pump 32 are thereby regulated. The control device 80 is an example of the first pump controlling section. For example, the control device 80 controls the frequency of the electricity supplied from the power source 46 to the booster pump 32 such that the flow rate of the ultrapure water of the flow rate detector 42 becomes 80 m³/h (see FIG. 2).

The value of the pressure detected by the pressure detector 66 of the return pipe 64 is inputted to the control device 80. In accordance with the pressure detected by the pressure detector 66, the control device 80 controls the open state of the regulating valve 68, and thereby regulates the pressure of the interior of the return pipe 64. For example, the control device 80 controls the regulating valve 68 such that the pressure of the pressure detector 66 becomes 343 kPa (i.e., 3.5 kgf/cm²) (see FIG. 2).

### Operation and Effects of First Embodiment

Operation and effects of the first embodiment are described next.

As illustrated in FIG. 1, in the liquid circulating system 10, the circulation path 60 that has the supply pipe 62 and the return pipe 64 is provided, and the primary pure water that is within the pure water tank 16 passes through the secondary pure water device 20 and is supplied to the point of use 50 by the supply pipe 62. At the secondary pure water device 20, the primary pure water is treated by the heat exchanger 24, the ultraviolet light irradiating device 26, the first ion exchanger 28, the membrane degasification device 30, the second ion exchanger 34 and the ultrafiltration device 36, respectively, and ultrapure water is thereby obtained. The ultrapure water obtained at the secondary pure water device 20 is supplied to the point of use 50. Moreover, the ultrapure water that is not used at the point of use 50 is returned to the pure water tank 16 by the return pipe 64.

As illustrated in FIG. 1 and FIG. 2, the pressure detector 66 is provided at the return pipe 64, and the pressure of the interior of the return pipe 64 is detected by the pressure detector 66. The regulating valve 68 is provided at the return pipe 64 at the downstream side of the pressure detector 66, and the pressure of the interior of the return pipe 64 is regulated by the regulating valve 68 in accordance with the pressure detected by the pressure detector 66.

Moreover, as illustrated in FIG. 1 and FIG. 2, the flow rate detector 42 is provided at the supply pipe 62 between the point of use 50 and the ultrafiltration device 36 that is the furthest downstream in the secondary pure water device 20. The flow rate of the liquid at the interior of the supply pipe 62 is detected by the flow rate detector 42. In accordance with the flow rate detected by the flow rate detector 42, the booster pump 32 is controlled by the control device 80 such that the primary pure water flowing through the supply pipe 62 becomes a predetermined flow rate. Due thereto, fluctuations in the flow rate of the ultrapure water that is supplied in the supply pipe 62 from the flow rate detector 42 to the point of use 50 are suppressed. Therefore, fluctuations in the flow rate of the ultrapure water supplied to the point of use 50 can be suppressed regardless of whether or not ultrapure water is used at the point of use 50.

Further, as illustrated in FIG. 1, in the liquid circulating system 10, the circulating pump 22 is provided at the supply pipe 62 at the downstream side of the pure water tank 16, and primary pure water within the pure water tank 16 is supplied by the circulating pump 22 toward the heat exchanger 24 of the secondary pure water device 20. The pressure detector 40 is provided at the supply pipe 62 at the upstream side of the booster pump 32, and the pressure of the interior of the supply pipe 62 is detected by the pressure detector 40. Further, in accordance with the pressure detected by the pressure detector 40, the circulating pump 22 is controlled by the control device 80 such that the pressure of the interior of the supply pipe 62 becomes a predetermined pressure. Therefore, at the time when primary pure water within the pure water tank 16 is passed-through the supply pipe 62 and supplied toward the heat exchanger 24 of the secondary pure water device 20 by the circulating pump 22, fluctuations in pressure of the interior of the supply pipe 62 at the position of the pressure detector 40 can be suppressed.

Further, in the liquid circulating system 10, the booster pump 32 is provided at the supply pipe 62 between the membrane degasification device 30 and the second ion exchanger 34. Due thereto, it is easy to control the flow rate of the primary pure water at the exit side of the booster pump 32, in accordance with the flow rate of the ultrapure water detected by the flow rate detector 42 that is at the supply pipe 62 between the point of use 50 and the ultrafiltration device 36 that is the furthest downstream. Therefore, fluctuations in the flow rate of the ultrapure water that is supplied to the point of use 50 can be suppressed more reliably.

### Example in which Ultrapure Water is not used at Point of Use

Here, an example is described in which ultrapure water is not used at the point of use 50 in the liquid circulating system 10. FIG. 2 illustrates a case in which ultrapure water is not used at the point of use 50 (i.e., a case in which the usage amount of the ultrapure water is 0 m³/h).

As illustrated in FIG. 2, the control device 80 controls the frequency of the power source 46 that supplies electricity to the booster pump 32, such that the flow rate of the ultrapure water of the flow rate detector 42 becomes 80 m³/h. At this time, at the point of use 50, for example, the actual pressure is 343 kPa (i.e., 3.5 kgf/cm²) with respect to a required pressure of 343 kPa (i.e., 3.5 kgf/cm²). The pressure at the point of use 50 is measured by an unillustrated pressure meter. Due thereto, the flow rate of the ultrapure water supplied to the point of use 50 by the supply pipe 62 is 80 m³/h, and the pressure difference (i.e., ΔP) between the pressure of the pressure detector 40 and the pressure of the point of use 50 is 49 kPa (i.e., 0.5 kgf/cm²).

In this example, because ultrapure water is not used at the point of use 50, the flow rate of the ultrapure water that is returned to the pure water tank 16 by the return pipe 64 is 80 m³/h. The control device 80 controls the pressure of the interior of the return pipe 64 by the regulating valve 68 such that the pressure of the pressure detector 66, which is provided at the return pipe 64 at the side of the junction with the point of use 50, becomes 343 kPa (i.e., 3.5 kgf/cm²).

### Example in Which Ultrapure Water is Used at Point of Use

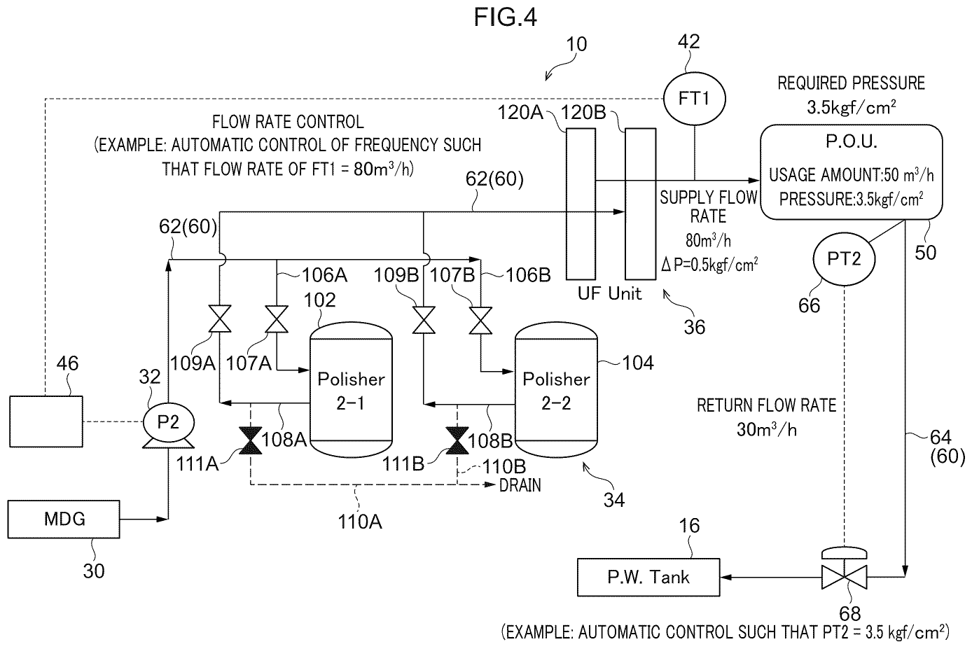

Next, by using FIG. 4, an example is described in which ultrapure water is used at the point of use 50 in the liquid circulating system 10.

As illustrated in FIG. 4, the control device 80 controls the frequency of the power source 46 that supplies electricity to the booster pump 32, such that the flow rate of the ultrapure water of the flow rate detector 42 becomes 80 m³/h. At this time, at the point of use 50, the actual pressure is 343 kPa (i.e., 3.5 kgf/cm²) with respect to a required pressure of 343 kPa (i.e., 3.5 kgf/cm²). Therefore, the flow rate of the ultrapure water supplied to the point of use 50 by the supply pipe 62 is 80 m³/h, and the pressure difference (i.e., ΔP) between the pressure of the interior of the supply pipe 62 (e.g., the pressure in a vicinity of the flow rate detector 42) and the pressure of the point of use 50 is 49 kPa (i.e., 0.5 kgf/cm²).

At the point of use 50, because the usage amount of ultrapure water is 50 m³/h for example, the flow rate of the ultrapure water that is returned to the pure water tank 16 by the return pipe 64 is 30 m³/h. The control device 80 controls the pressure of the interior of the return pipe 64 by the regulating valve 68 such that the pressure of the pressure detector 66, which is provided at the return pipe 64 at the side near to the junction with the point of use 50, becomes 343 kPa (i.e., 3.5 kgf/cm²).

As described above, in the liquid circulating system 10, fluctuations in the flow rate of the ultrapure water supplied to the point of use 50 can be suppressed regardless of whether or not the ultrapure water is being used at the point of use 50. Further, in the liquid circulating system 10, because fluctuations in the flow rate of the ultrapure water are small, a deterioration in the water quality of the ultrapure water due to fluctuations in the flow rate is kept to a minimum.

### Position of Pressure Detector

In the liquid circulating system 10, the pressure detector 66 is provided at a position that, from the junction with the point of use 50 at the return pipe 64, is less than 20% of the length of the return pipe 64 between this junction and the pure water tank 16.

A structure is described in which, in a case in which the length of the return pipe between the pure water tank and the point of use is long for example, a pressure detecting section is provided at a position that is 20% or more of the length of the return pipe 64 from the junction with the point of use at the return pipe to the pure water tank 16. In this structure, when usage of ultrapure water starts at the point of use, if the opening diameter of the return pipe is the same, the flow rate of the ultrapure water in the return pipe decreases, and the pressure loss decreases. Accordingly, at a pressure detecting section that is provided at a position that is 20% or more of the length of the return pipe 64 from the junction with the point of use at the return pipe, there is the possibility that the pressure of the interior of the return pipe will not be regulated appropriately by the regulating valve 68.

In contrast, in the liquid circulating system 10, the pressure detector 66 is provided at a position that is less than 20% of the length of the return pipe 64 from the junction with the point of use 50 at the return pipe 64. Even if the flow rate of the ultrapure water of the return pipe 64 decreases, the decrease in the pressure loss can be ignored. Therefore, the pressure of the interior of the return pipe 64 can be regulated appropriately by the regulating valve 68 in accordance with the pressure detected by the pressure detector 66. Note that the place where the regulating valve 68 is set is not particularly limited provided that the regulating valve is downstream of the pressure detector 66 of the return pipe 64.

### Liquid Circulating System of First Comparative Example

Here, a liquid circulating system of a first comparative example is described. Note that structural portions that are the same as those of the above-described first embodiment are denoted by the same reference numerals, and description thereof is omitted.

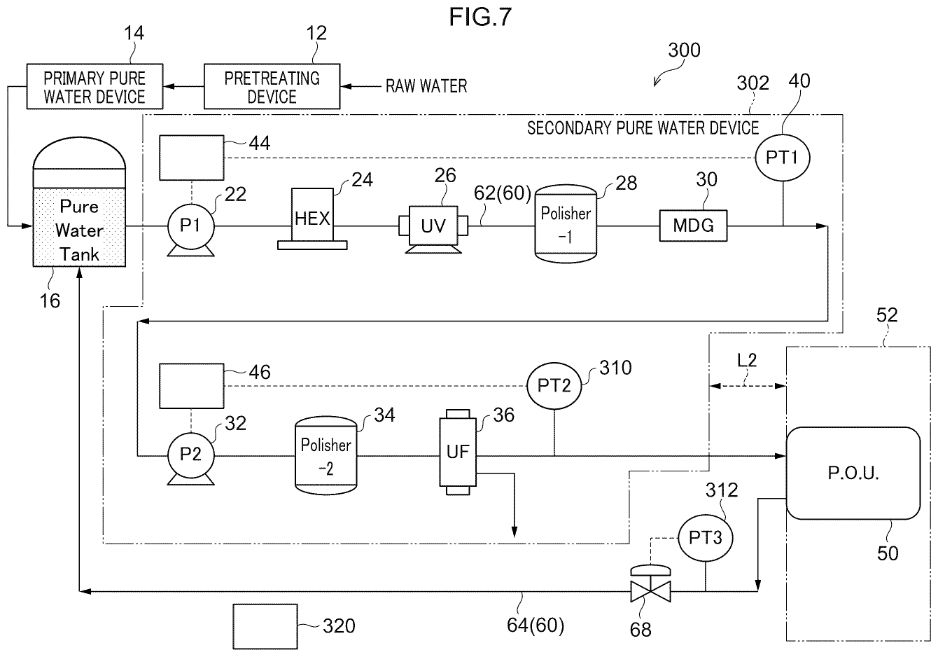

As illustrated in FIG. 7, a liquid circulating system 300 of the first comparative example has the secondary pure water device 302 and a control device 320 as structures that differ from the liquid circulating system 10 of the first embodiment. A second pressure detector (e.g., PT2) 310, which detects the pressure of the interior of the supply pipe 62, is provided in the secondary pure water device 302, between the point of use 50 and the ultrafiltration device 36 that is the furthest downstream. On the basis of the pressure detected by the second pressure detector 310, the control device 320 controls the frequency of the power source 46 that supplies electricity to the booster pump 32. Namely, in the liquid circulating system 300, the flow rate detector 42 (see FIG. 1) such as that of the liquid circulating system 10 of the first embodiment is not provided. In the liquid circulating system 300, length L2 of the supply pipe 62 from the downstream side end portion of the secondary pure water device 302 to the portion connected to the point of use 50 is, for example, 0.5 km or more and 1.5 km or less.

Further, in the liquid circulating system 300, a third pressure detector (e.g., PT3) 312 that detects the pressure of the interior of the return pipe 64 is provided as a structure that is different than the liquid circulating system 10 of the first embodiment, at the return pipe 64 at the upstream side of the regulating valve 68 and at the side near the pure water tank 16. The control device 320 controls the pressure of the interior of the return pipe 64 by controlling the open state of the regulating valve 68 in accordance with the pressure detected by the third pressure detector 66. The control device 320 regulates the pressure of the interior of the return pipe 64 by controlling the open state of the regulating valve 68 such that the pressure of the third pressure detector 312 becomes 294 kPa (i.e., 3 kgf/cm²) for example. In the liquid circulating system 300, the length of the return pipe 64 from the junction with the point of use 50 at the return pipe 64 to the third pressure detector 312 is, for example, 0.5 km or more and 1.5 km or less. The third pressure detector 312 is, for example, provided at a position that is 80% or more of the length of the return pipe 64 from the junction with the point of use 50 at the return pipe 64.

### Example in which Ultrapure Water is not Used at Point of Use

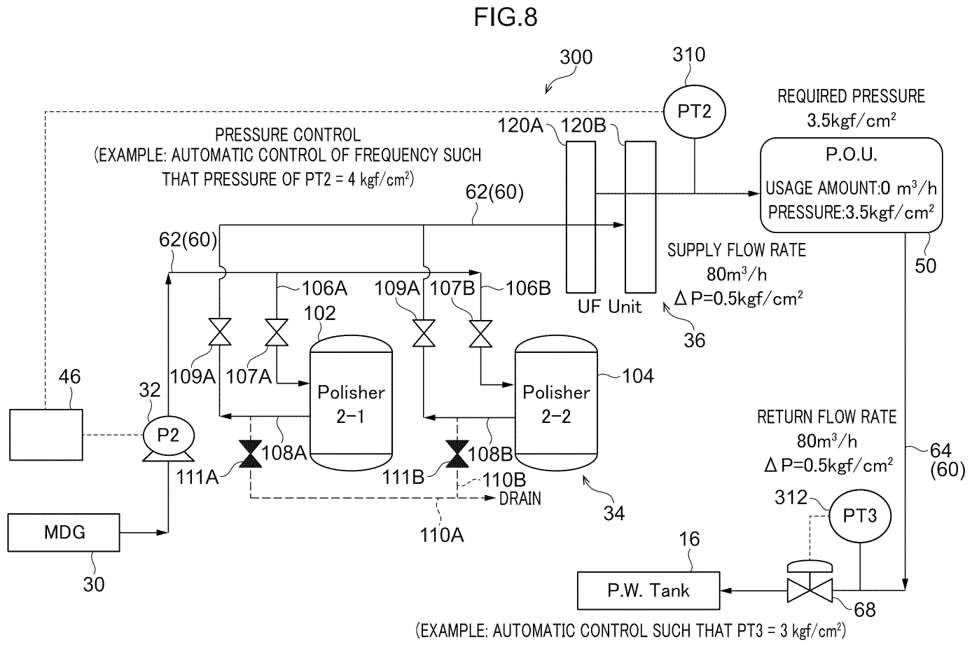

As illustrated in FIG. 8, at the liquid circulating system 300 of the first comparative example, in a case in which ultrapure water is not used at the point of use 50 (i.e., a case in which the usage amount of ultrapure water is 0 m³/h), the control device 320 controls the frequency of the power source 46 that supplies electricity to the booster pump 32 such that, for example, the pressure of the second pressure detector 310 becomes 392 kPa (i.e., 4 kgf/cm²). At this time, at the point of use 50, the actual pressure is 343 kPa (i.e., 3.5 kgf/cm²) with respect to a required pressure of 343 kPa (i.e., 3.5 kgf/cm²). The flow rate of the ultrapure water supplied to the point of use 50 by the supply pipe 62 is 80 m³/h, and the pressure difference (i.e., ΔP) between the pressure of the second pressure detector 310 and the pressure of the point of use 50 is 49 kPa (i.e., 0.5 kgf/cm²).

Because ultrapure water is not used at the point of use 50 (i.e., because the usage amount of ultrapure water is 0 m³/h), the flow rate of the ultrapure water that is returned toward the pure water tank 16 by the return pipe 64 is 80 m³/h. The control device 320 controls the pressure of the interior of the return pipe 64 by the regulating valve 68 such that the pressure of the third pressure detector 312 of the return pipe 64 becomes 294 kPa (i.e., 3 kgf/cm²). At this time, the pressure difference (i.e., ΔP) between the pressure of the point of use 50 and the pressure of the third pressure detector 312 is 49 kPa (i.e., 0.5 kgf/cm²).

### Example in which Ultrapure Water is Used at Point of Use

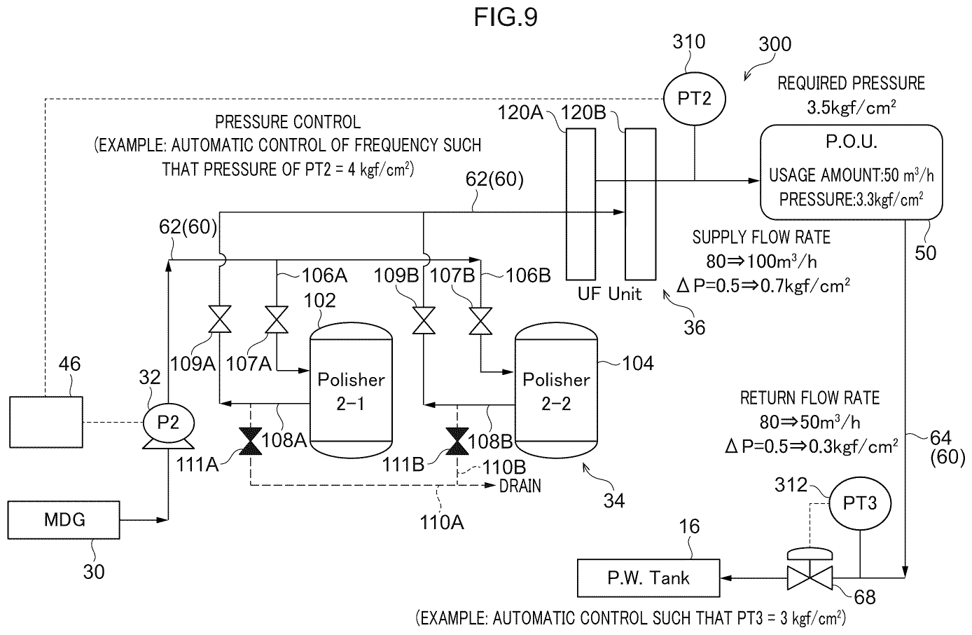

FIG. 9 illustrates an example in which ultrapure water is used at 50 m³/h at the point of use 50 in the liquid circulating system 300. As illustrated in FIG. 9, at the return pipe 64, the set pressure of the regulating valve 68 is controlled by the third pressure detector 312 to 294 kPa (i.e., 3 kgf/cm²). When usage of ultrapure water starts at the point of use 50, if the opening diameter of the return pipe 64 is the same, the flow rate of the ultrapure water in the return pipe 64 decreases, and the pressure loss decreases. For example, the pressure difference (i.e., ΔP) between the pressure of the point of use 50 and the pressure of the third pressure detector 312 changes from 49 kPa (i.e., 0.5 kgf/cm²) to 29.4 kPa (i.e., 0.3 kgf/cm²).

At the point of use 50, the actual pressure is 323.4 kPa (i.e., 3.3 kgf/cm²) with respect to a required pressure of 343 kPa (i.e., 3.5 kgf/cm²), and the pressure falls. At this time, the pressure of the second pressure detector 310 is controlled so as to become 392 kPa (i.e., 4 kgf/cm²). The pressure difference (i.e., ΔP) between the pressure of the second pressure detector 310 and the pressure of the point of use 50 becomes 68.6 kPa (i.e., 0.7 kgf/cm²), and the pressure loss increases, and the supply flow rate increases. For example, although it is desired that the supply flow rate of the ultrapure water of the supply pipe 62 actually be 80 m³/h, the supply flow rate increases to 100 m³/h. Namely, the actual supply flow rate of the ultrapure water increases with respect to the designed flow rate of the ultrapure water of the supply pipe 62. Therefore, there is the possibility that the change in pressure will affect the quality of the ultrapure water. Further, because the operating conditions of the semiconductor fabricating devices or the like that are set at the point of use change, there is also the concern that the yield of the products will be affected.

Note that, for convenience of maintenance, the third pressure detector 312 and the regulating valve 68 are usually set in a vicinity of the pure water tank 16. Namely, if the third pressure detector 312 and the regulating valve 68 are set in a vicinity of the point of use, for example, they are set in a building that is different than the building in which the pure water device is set, or on a different floor, or within a clean room or in the vicinity of a clean room. Therefore, the third pressure detector 312 and the regulating valve 68 are generally not set in such a place because the ability to maintain them would be greatly diminished.

### Liquid Circulating System of Second Comparative Example

A liquid circulating system of a second comparative example is described next. Note that structural portions that are the same as those of the above-described first embodiment and first comparative example are denoted by the same reference numerals, and description thereof is omitted.

### Example in which Ultrapure Water is used at Point of Use

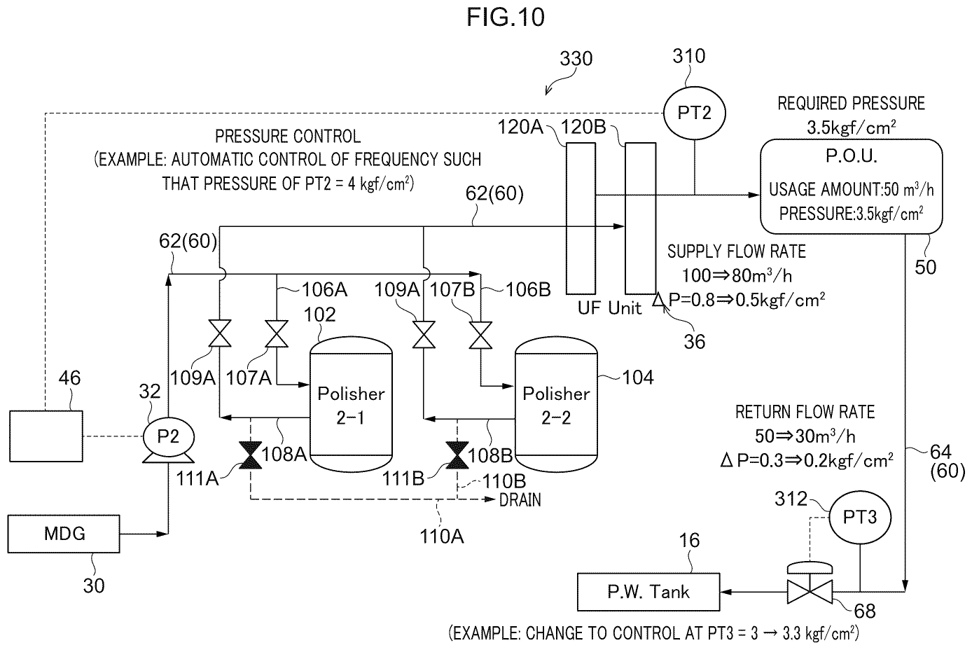

FIG. 10 illustrates an example in which, in a liquid circulating system 330 of a second comparative example, ultrapure water is used at the point of use 50 at 50 m³/h for example. FIG. 10 is an example in which the setting of the third pressure detector 312 is changed immediately after the state illustrated in FIG. 9 is established. Namely, as illustrated in FIG. 10, in the liquid circulating system 330 of the second comparative example, the set pressure of the third pressure detector 312 is manually changed so as to be controlled at 323.4 kPa (i.e., 3.3 kgf/cm²), and the opening of the regulating valve 68 is throttled. Due thereto, as compared with the liquid circulating system 330 of the first comparative example, the flow rate of the ultrapure water that is returned by the return pipe 64 decreases from 50 m³/h to 30 m³/h, and the pressure loss of the return pipe 64 decreases. The pressure of the point of use 50 becomes 343 kPa (i.e., 3.3+0.2=3.5 kgf/cm²). Moreover, the pressure difference (i.e., ΔP) between the second pressure detector 310 of the supply pipe 62 and the point of use 50 returns to 49 kPa (i.e., 0.5 kgf/cm²), and the supply rate of the ultrapure water of the supply pipe 62 also returns to 80 m³/h.

However, in the liquid circulating system 330, if the set pressure of the third pressure detector 312 is suddenly changed manually so as to be controlled at 323.4 kPa (i.e., 3.3 kgf/cm²), there is the possibility that the water quality of the ultrapure water will deteriorate. Further, because two types of pressure control that are control of the booster pump 32 in accordance with the second pressure detector 310 and control of the regulating valve 68 in accordance with the third pressure detector 312 are necessary, control of the operation system becomes complex.

In contrast, in the liquid circulating system 10 of the first embodiment, the control device 80 controls the frequency of the power source 46 that supplies electricity to the booster pump 32, in accordance with the flow rate of the ultrapure water of the flow rate detector 42 that is at the supply pipe 62 between the ultrafiltration device 36 and the point of use 50. Due thereto, fluctuations in the flow rate of the ultrapure water that is supplied to the point of use 50 by the supply pipe 62 are suppressed. Therefore, fluctuations in the flow rate of the ultrapure water supplied to the point of use 50 by the supply pipe 62 can be suppressed regardless of whether or not ultrapure water is being used at the point of use 50.

Further, at the liquid circulating system 10, the pressure detector 66 is provided at a position that, from the junction with the point of use 50 at the return pipe 64, is less than 20% of the length of the return pipe 64. Therefore, even if the flow rate of the ultrapure water of the return pipe 64 decreases, the decrease in the pressure loss can be ignored. Accordingly, the pressure of the interior of the return pipe 64 can be regulated appropriately by the regulating valve 68, in accordance with the pressure detected by the pressure detector 66.

### First Example of Maintenance at Liquid Circulating System of First Embodiment

A first example of maintenance at the liquid circulating system 10 of the first embodiment is described next.

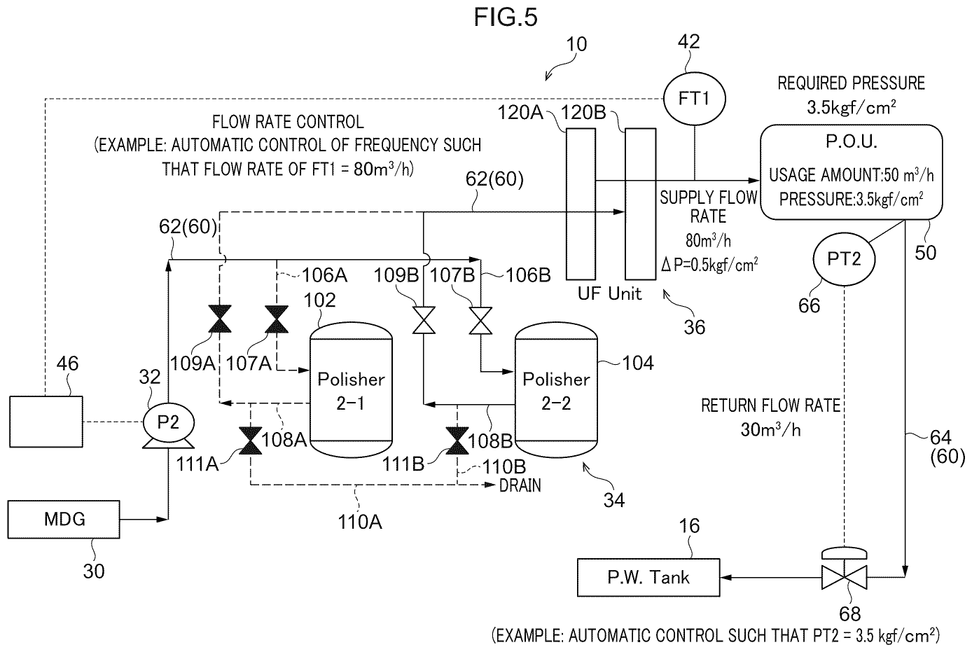

FIG. 5 illustrates a state in which the first ion exchange resin treatment section 102 of the second ion exchanger 34 is stopped at the time of maintenance of the liquid circulating system 10. As illustrated in FIG. 5, in the liquid circulating system 10, changing of the usage amount of ultrapure water at the point of use 50, and the first ion exchange resin treatment section 102, are being carried out simultaneously. At the point of use, the usage amount of ultrapure water is 50 m³/h.

In the liquid circulating system 10, by closing the valve 107A of the introducing pipe 106A and closing the valve 109A of the discharge pipe 108A, primary pure water no longer flows to the first ion exchange resin treatment section 102. Due thereto, the first ion exchange resin treatment section 102 stops, and maintenance of the first ion exchange resin treatment section 102 can be carried out. Further, the valves 111A, 111B also are closed. By opening the valve 107B of the introducing pipe 106B and opening the valve 109B of the discharge pipe 108B, primary pure water flows only to the second ion exchange resin treatment section 104. The primary pure water that has been treated at the second ion exchange resin treatment section 104 is supplied from the discharge pipe 108B via the supply pipe 62 to the ultrafiltration device 36.

The control device 80 controls the frequency of the power source 46 that supplies electricity to the booster pump 32, such that the flow rate of the ultrapure water of the flow rate detector 42 becomes 80 m³/h. Due thereto, the supply rate of the ultrapure water that is supplied to the point of use 50 by the supply pipe 62 becomes 80 m³/h.

Operation and effects in accordance with the structure of the second ion exchanger 34 of the liquid circulating system 10 of the present embodiment are described here.

In the liquid circulating system 10, the second ion exchanger 34 has the first ion exchange resin treatment section 102 and the second ion exchange resin treatment section 104 that are connected in parallel to the supply pipe 62. In a state in which the valve 107A and the valve 109A of the first ion exchange resin treatment section 102 are opened, and the valve 107B and the valve 109B of the second ion exchange resin treatment section 104 are opened, primary pure water is introduced respectively into the first ion exchange resin treatment section 102 and the second ion exchange resin treatment section 104, and the primary pure water that has been treated at the first ion exchange resin treatment section 102 and the second ion exchange resin treatment section 104 is discharged (see FIG. 4). In such a structure, one of the first ion exchange resin treatment section 102 and the second ion exchange resin treatment section 104 can be stopped and maintenance carried out thereon, and primary pure water can be made to pass through the other of the first ion exchange resin treatment section 102 and the second ion exchange resin treatment section 104. Therefore, maintenance of one of the first ion exchange resin treatment section 102 and the second ion exchange resin treatment section 104 can be carried out while operation of the liquid circulating system 10 is continued as is.

Further, in the liquid circulating system 10, at the time of maintenance of the second ion exchanger 34, one of the first ion exchange resin treatment section 102 and the second ion exchange resin treatment section 104 is stopped, and the primary pure water that has passed through the other of the first ion exchange resin treatment section 102 and the second ion exchange resin treatment section 104 is supplied to the ultrafiltration device 36. For example, the first ion exchange resin treatment section 102 is stopped, and the primary pure water that has passed through the second ion exchange resin treatment section 104 is supplied to the ultrafiltration device 36 (see FIG. 5).

As illustrated in FIG. 5, in the liquid circulating system 10, the booster pump 32 is controlled in accordance with the flow rate of the ultrapure water detected by the flow rate detector 42 that is at the supply pipe 62 between the point of use 50 and the ultrafiltration device 36 that is the furthest downstream. For example, the control device 80 controls the frequency of the power source 46 that supplies electricity to the booster pump 32 such that the flow rate of the ultrapure water of the flow rate detector 42 becomes 80 m³/h. Due thereto, because there are two types of control that are control of the booster pump 32 in accordance with the flow rate detector 42 and control of the regulating valve 68 in accordance with the pressure detector 66, the operating flow rate of the ultrapure water of the liquid circulating system 10 can be stabilized. Therefore, in the liquid circulating system 10, even if changing of the usage amount of ultrapure water at the point of use 50 and stoppage of the first ion exchange resin treatment section 102 are carried out simultaneously, the supply flow rate of ultrapure water to the point of use 50 and the pressure at the point of use 50 can be maintained substantially constant.

### First Example of Maintenance at Liquid Circulating System of First Comparative Example

A first example of maintenance at the liquid circulating system 300 of the first comparative example is described next.

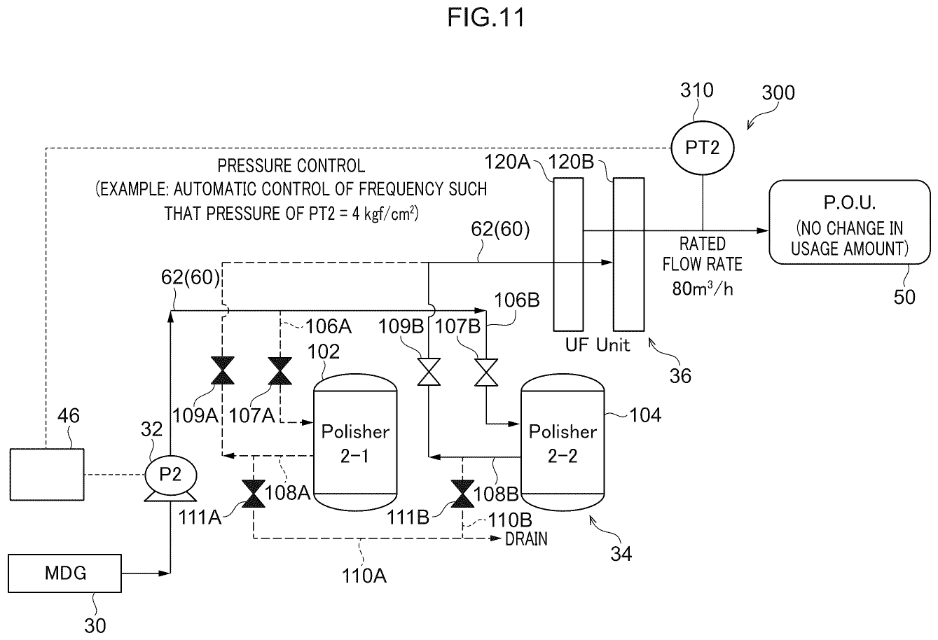

FIG. 11 illustrates an example of maintenance of the second ion exchanger 34 in a case in which there is no change in the usage amount of ultrapure water at the point of use 50 (i.e., a case in which ultrapure water is not used) in the liquid circulating system 300 of the first comparative example. As illustrated in FIG. 11, when the first ion exchange resin treatment section 102 of the second ion exchanger 34 is stopped, the pressure loss at the second ion exchange resin treatment section 104 increases. This amount of increase in the pressure loss is compensated for by an increase in the frequency of the power source 46 that supplies electricity to the booster pump 32.

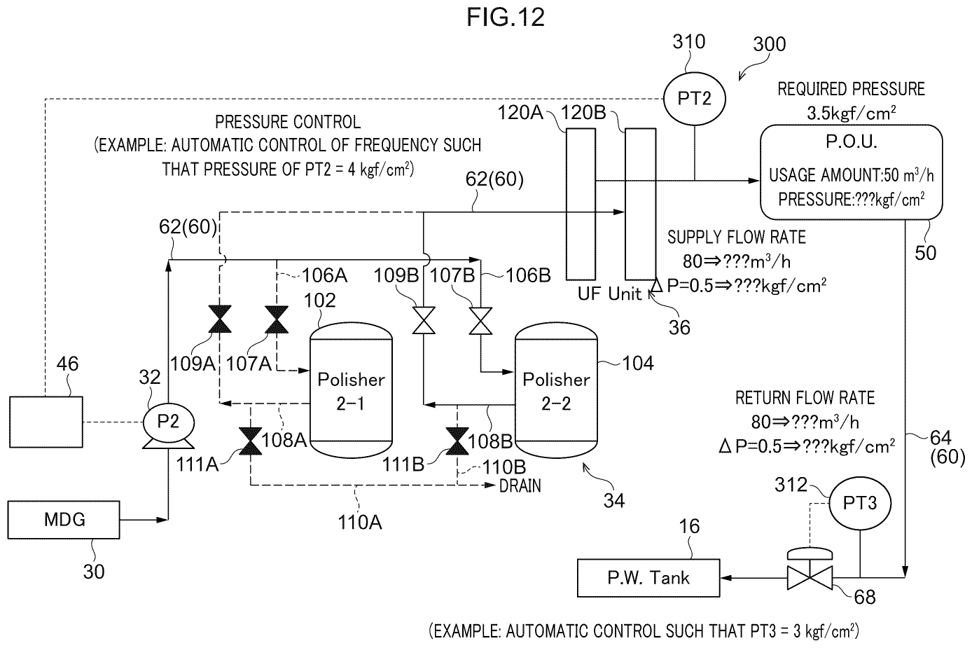

FIG. 12 illustrates an example of maintenance of the second ion exchanger 34 in a case in which the usage amount of ultrapure water at the point of use 50 is changed (e.g., a case in which ultrapure water is used at 50 m³/h) in the liquid circulating system 300 of the first comparative example. As illustrated in FIG. 12, in the liquid circulating system 300, in a case in which changing of the usage amount of ultrapure water at the point of use 50 and stoppage of the first ion exchange resin treatment section 102 are carried out simultaneously, control of the booster pump 32 in accordance with the second pressure detector 310 and control of the regulating valve 68 in accordance with the third pressure detector 312 must be carried out. At this time, because there are two types of automatic pressure control at the same system, fluctuations in the flow rate and the pressure of the ultrapure water cannot be predicted. Therefore, depending on the timing, there is the possibility that the operating flow rate of the liquid circulating system 300 will change, and that it will not be possible to return the operating flow rate to its original state, and the operating state of the liquid circulating system 300 becomes unstable.

In contrast, in the liquid circulating system 10 of the first embodiment, the booster pump 32 is controlled in accordance with the flow rate of ultrapure water detected by the flow rate detector 42 that is at the supply pipe 62 between the point of use 50 and the ultrafiltration device 36 that is the furthest downstream. Due thereto, there is control of the booster pump 32 in accordance with the flow rate detector 42 and control of the regulating valve 68 in accordance with the pressure detector 66. Therefore, in the liquid circulating system 10, even if changing of the usage amount of ultrapure water at the point of use 50 and stoppage of the first ion exchange resin treatment section 102 are carried out simultaneously, the supply flow rate of ultrapure water to the point of use 50 and the pressure at the point of use 50 can be maintained substantially constant.

### Second Example of Maintenance at Liquid Circulating System of First Embodiment

A second example of maintenance at the liquid circulating system 10 of the first embodiment is described next.

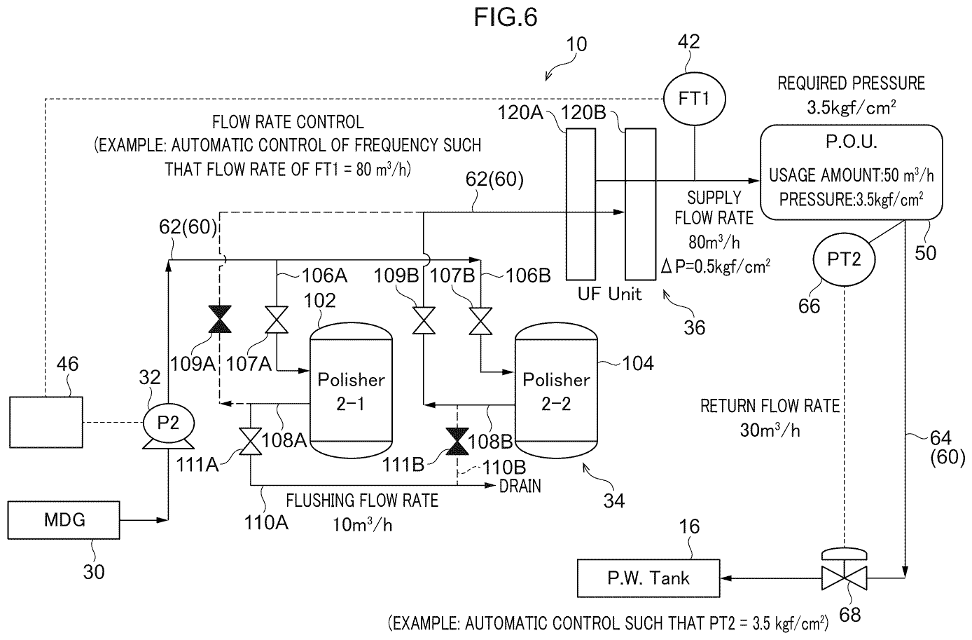

FIG. 6 illustrates a state in which cleaning of the ion exchange resin of the first ion exchange resin treatment section 102 of the second ion exchanger 34 is carried out at the time of maintenance of the liquid circulating system 10. As illustrated in FIG. 6, in the liquid circulating system 10, changing of the usage amount of ultrapure water at the point of use 50, and washing of the ion exchange resin of the first ion exchange resin treatment section 102, are being carried out simultaneously. At the point of use 50, the usage amount of ultrapure water is 50 m³/h.

In the liquid circulating system 10, by opening the valve 107A of the introducing pipe 106A and closing the valve 109A of the discharge pipe 108A and opening the valve 111A of the discharge path 110A, the primary pure water that has passed through the first ion exchange resin treatment section 102 is discharged to the discharge path 110A. Due thereto, washing of the ion exchange resin of the first ion exchange resin treatment section 102 can be carried out. Further, by opening the valve 107B of the introducing pipe 106B and opening the valve 109B of the discharge pipe 108B and closing the valve 111B, the primary pure water that has passed through the second ion exchange resin treatment section 104 is supplied from the discharge pipe 108B via the supply pipe 62 to the ultrafiltration device 36. The flow rate at the time of washing the ion exchange resin of the first ion exchange resin treatment section 102 is 10 m³/h.

The control device 80 controls the frequency of the power source 46 that supplies electricity to the booster pump 32, such that the flow rate of the ultrapure water of the flow rate detector 42 becomes 80 m³/h. Due thereto, the supply rate of the ultrapure water that is supplied to the point of use 50 by the supply pipe 62 becomes 80 m³/h.

In the above-described liquid circulating system 10, at the time of maintenance of the second ion exchanger 34, primary pure water is introduced into the first ion exchange resin treatment section 102 and washes the ion exchange resin, and the liquid used in washing is discharged to the discharge path 110A. Together therewith, the primary pure water that has passed through the second ion exchange resin treatment section 104 is supplied to the ultrafiltration device 36. At this time, the booster pump 32 is controlled in accordance with the flow rate of the ultrapure water detected by the flow rate detector 42 that is at the supply pipe 62 between the point of use 50 and the ultrafiltration device 36 that is the furthest downstream. For example, the control device 80 controls the frequency of the power source 46 that supplies electricity to the booster pump 32 such that the flow rate of the ultrapure water of the flow rate detector 42 becomes 80 m³/h. Due thereto, because there is control of the booster pump 32 in accordance with the flow rate detector 42 and control of the regulating valve 68 in accordance with the pressure detector 66, the operating flow rate of the ultrapure water in the liquid circulating system 10 can be stabilized. Therefore, in the liquid circulating system 10, even if changing of the usage amount of ultrapure water at the point of use 50 and washing of the ion exchange resin of the first ion exchange resin treatment section 102 are carried out simultaneously, the supply flow rate of ultrapure water to the point of use 50 and the pressure at the point of use 50 can be maintained substantially constant.

### Second Example of Maintenance at Liquid Circulating System of First Comparative Example

A second example of maintenance at the liquid circulating system 300 of the first comparative example is described next.

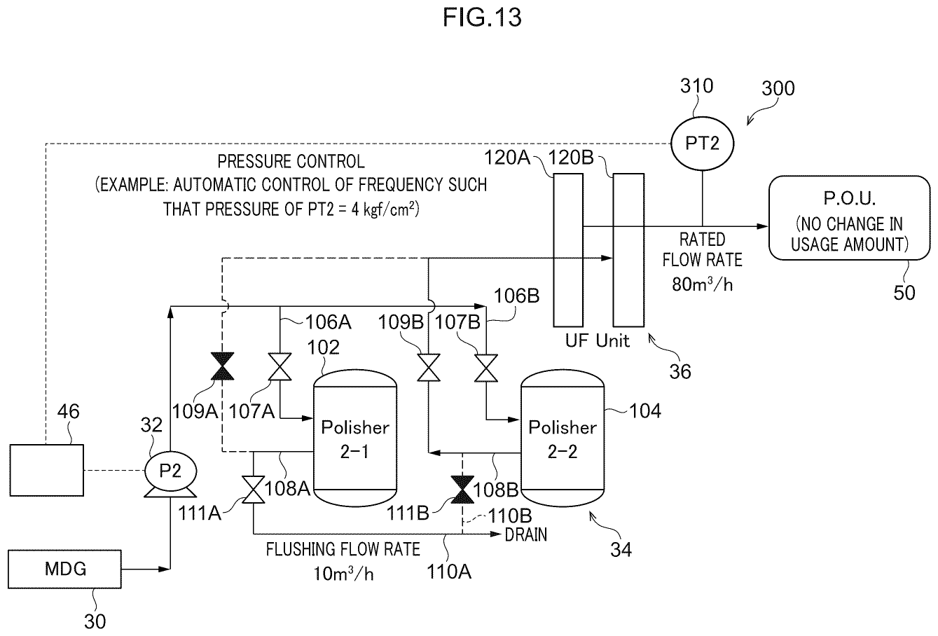

FIG. 13 illustrates an example of maintenance of the second ion exchanger 34 in a case in which there is no change in the usage amount of ultrapure water at the point of use 50 (i.e., a case in which ultrapure water is not used) in the liquid circulating system 300 of the first comparative example. As illustrated in FIG. 13, when washing of the ion exchange resin of the first ion exchange resin treatment section 102 is carried out, the washing flow rate at which the water used in washing is discharged to the discharge path 110A increases. This amount of increase in the washing flow rate is compensated for by an increase in the frequency of the power source 46 that supplies electricity to the booster pump 32.

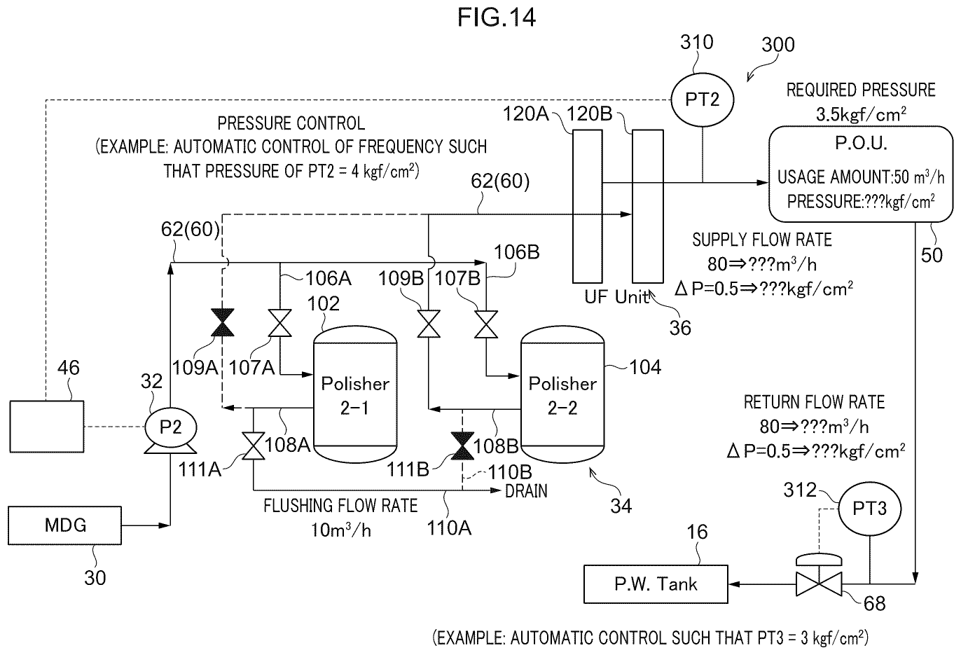

FIG. 14 illustrates an example of maintenance of the second ion exchanger 34 in a case in which the usage amount of ultrapure water at the point of use 50 is changed (e.g., a case in which ultrapure water is used at 50 m³/h) in the liquid circulating system 300 of the first comparative example. As illustrated in FIG. 14, in the liquid circulating system 300, in a case in which changing of the usage amount of ultrapure water at the point of use 50 and washing of the ion exchange resin of the first ion exchange resin treatment section 102 are carried out simultaneously, control of the booster pump 32 in accordance with the second pressure detector 310 and control of the regulating valve 68 in accordance with the third pressure detector 312 must be carried out. At this time, because there are two types of automatic pressure control at the same system, fluctuations in the flow rate and the pressure of the ultrapure water cannot be predicted, and the operating state of the liquid circulating system 300 becomes more unstable.

In contrast, in the liquid circulating system 10 of the first embodiment, the booster pump 32 is controlled in accordance with the flow rate of ultrapure water detected by the flow rate detector 42 that is at the supply pipe 62 between the point of use 50 and the ultrafiltration device 36 that is the furthest downstream. Due thereto, there are two types of control that are control of the booster pump 32 in accordance with the flow rate detector 42 and control of the regulating valve 68 in accordance with the pressure detector 66. Therefore, in the liquid circulating system 10, even if changing of the usage amount of ultrapure water at the point of use 50 and washing of the ion exchange resin of the first ion exchange resin treatment section 102 are carried out simultaneously, the supply flow rate of ultrapure water to the point of use 50 and the pressure at the point of use 50 can be maintained substantially constant.

### Other Points

Note that, instead of the structure of the liquid circulating system 10 of the first embodiment, the position of the pressure detector 66 may be changed under the following conditions. The pressure detector 66 is nearer to the point of use 50 than the pure water tank 16 at the return pipe 64, and, when comparing the differential pressure of the times when the flow rate of the ultrapure water in the return pipe 64 is a maximum and a minimum, the pressure detector 66 is preferably provided at a position at which the differential pressure is less than or equal to 9.8 kPa (i.e., 0.1 kgf/cm²), and is more preferably provided at a position at which the differential pressure is less than or equal to 4.9 kPa (i.e., 0.05 kgf/cm²), and is even more preferably provided at a position at which the differential pressure is less than or equal to 2.94 kPa (i.e., 0.03 kgf/cm²).

For example, when the pressure detector 66 is provided at the return pipe 64 at the side nearer to the point of use 50 than the pure water tank 16, and at a position at which the differential pressure of times when the flow rate of the ultrapure water in the return pipe 64 is a maximum and a minimum is less than or equal to 9.8 kPa (i.e., 0.1 kgf/cm²), even if the flow rate of the ultrapure water in the return pipe 64 decreases, it is difficult to be affected by the decrease in the pressure loss. Therefore, the pressure of the interior of the return pipe 64 can be regulated appropriately by the regulating valve 68 in accordance with the pressure detected by the pressure detector 66.

Further, in a structure in which plural junction points to the point of use 50 are provided at the circulation path 60, there may be a structure in which the pressure detector 66 is provided at the return pipe at the side nearer to the final stage of a junction with the point of use than the pure water tank 16, and at a position at which, when comparing the differential pressure of times when the flow rate of the liquid in the return pipe is a maximum and a minimum, the differential pressure is less than or equal to 9.8 kPa (i.e., 0.1 kgf/cm²).

Note that, although the present disclosure has been described in detail by way of a specific embodiment, the present disclosure is not limited to this embodiment, and it will be clear to those skilled in the art the various other embodiments are possible within the scope of the present disclosure.

### Preferred Aspects of Present Disclosure

Preferred aspects of the present disclosure are noted as follows.

### Note 1

A liquid circulating system having:
a tank storing a liquid;
plural treatment sections carrying out respectively different treatments on liquid supplied from the tank;
a circulation path having a supply pipe that supplies liquid within the tank via the plural treatment sections to a point of use that is a supply destination, and a return pipe that returns liquid from the point of use to the tank;
a first pump provided at the supply pipe in the midst of the plural treatment sections, and supplying liquid toward the point of use;
a first pressure detecting section provided at the return pipe, and detecting pressure of an interior of the return pipe;
a regulating valve provided at the return pipe at a downstream side of the first pressure detecting section, and regulating pressure of the interior of the return pipe in accordance with the pressure detected by the first pressure detecting section;
a flow rate detecting section provided at the supply pipe between the point of use and a treatment section that is furthest downstream among the plural treatment sections, and detecting a flow rate of liquid at an interior of the supply pipe; and
a first pump controlling section that, in accordance with the flow rate detected by the flow rate detecting section, controls the first pump such that liquid flowing in the supply pipe becomes a predetermined flow rate.

### Note 2

The liquid circulating system of Note 1, having:
a second pump provided at the supply pipe at a downstream side of the tank, and supplying liquid within the tank toward the plural treatment sections;
a second pressure detecting section provided at the supply pipe at an upstream side of the first pump, and detecting pressure of the interior of the supply pipe; and
a second pump controlling section that, in accordance with the pressure detected by the second pressure detecting section, controls the second pump such that the pressure of the interior of the supply pipe becomes a predetermined pressure.

### Note 3

The liquid circulating system of Note 1 or Note 2, wherein the first pressure detecting section is provided at a place that, from a final stage of a junction with the point of use at the return pipe, is less than 20% of a length of the return pipe between the final stage and the tank.

### Note 4

The liquid circulating system of Note 1 or Note 2, wherein the first pressure detecting section is provided at the return pipe at a side nearer to a final stage of a junction with the point of use than the tank, and at a place at which, when comparing a differential pressure of times when a flow rate of liquid in the return pipe is a maximum and a minimum, the differential pressure is less than or equal to 9.8 kPa.

### Note 5

The liquid circulating system of any one of Note 1 through Note 4, wherein the first pump is a booster pump that supplies liquid by applying an insufficient amount of pressure of the supply pipe.

### Note 6

The liquid circulating system of Claim 1, wherein:
the plurality of treatment sections include:
   a filtration device structuring the treatment section that is furthest downstream, and having an ultrafiltration membrane; and
   an ion exchanger provided at an upstream side of and immediately before the filtration device, and having an ion exchange resin, and
the ion exchanger has two or more ion exchange resin treatment sections that are connected in parallel to the supply pipe, and to and from which liquid is introduced and discharged respectively.

### Note 7

The liquid circulating system of Note 6, wherein the system is structured such that, at a time of maintenance of the ion exchanger, one of the ion exchange resin treatment sections is stopped, and liquid that has passed through another of the ion exchange resin treatment sections is supplied to the filtration device.

### Note 8

The liquid circulating system of Note 6, wherein the system is structured such that at a time of maintenance of the ion exchanger,
liquid is introduced into one of the ion exchange resin treatment sections and washes the ion exchange resin, and liquid that has been used in washing is discharged to a discharge path that is other than the supply pipe, and
liquid is introduced into another of the ion exchange resin treatment sections, and liquid that has passed through the other of the ion exchange resin treatment sections is supplied to the filtration device.

The disclosure of Japanese Patent Application No. 2023-098744 is, in its entirety, incorporated by reference into the present specification.

All publications, patent applications, and technical standards mentioned in the present specification are incorporated by reference into the present specification to the same extent as if such individual publication, patent application, or technical standard was specifically and individually indicated to be incorporated by reference.

1. A liquid circulating system comprising:
a tank storing a liquid;
a plurality of treatment sections carrying out respectively different treatments on liquid supplied from the tank;
a circulation path having a supply pipe that supplies liquid within the tank via the plurality of treatment sections to a point of use that is a supply destination, and a return pipe that returns liquid from the point of use to the tank;
a first pump provided at the supply pipe in the midst of the plurality of treatment sections, and supplying liquid toward the point of use;
a first pressure detecting section provided at the return pipe, and detecting pressure of an interior of the return pipe;
a regulating valve provided at the return pipe at a downstream side of the first pressure detecting section, and regulating pressure of the interior of the return pipe in accordance with the pressure detected by the first pressure detecting section;
a flow rate detecting section provided at the supply pipe between the point of use and a treatment section that is furthest downstream among the plurality of treatment sections, and detecting a flow rate of liquid at an interior of the supply pipe; and
a first pump controlling section that, in accordance with the flow rate detected by the flow rate detecting section, controls the first pump such that a flow rate of liquid flowing in the supply pipe becomes a predetermined flow rate.

2. The liquid circulating system of claim 1, comprising:
a second pump provided at the supply pipe at a downstream side of the tank, and supplying liquid within the tank toward the plurality of treatment sections;
a second pressure detecting section provided at the supply pipe at an upstream side of the first pump, and detecting pressure of the interior of the supply pipe; and
a second pump controlling section that, in accordance with the pressure detected by the second pressure detecting section, controls the second pump such that the pressure of the interior of the supply pipe becomes a predetermined pressure.

3. The liquid circulating system of claim 1, wherein the first pressure detecting section is provided at a place that, from a final stage of a junction with the point of use at the return pipe, is less than 20% of a length of the return pipe between the final stage and the tank.

4. (canceled)

5. The liquid circulating system of claim 1, wherein the first pump is a booster pump that supplies liquid by applying an insufficient amount of pressure of the supply pipe.

6. The liquid circulating system of claim 1, wherein:
the plurality of treatment sections include:
a filtration device structuring the treatment section that is furthest downstream, and having an ultrafiltration membrane; and
an ion exchanger provided at an upstream side of and immediately before the filtration device, and having an ion exchange resin, and
the ion exchanger has two or more ion exchange resin treatment sections that are connected in parallel to the supply pipe, and to and from which liquid is introduced and discharged respectively.

7. The liquid circulating system of claim 6, wherein the system is structured such that, at a time of maintenance of the ion exchanger, one of the ion exchange resin treatment sections is stopped, and liquid that has passed through another of the ion exchange resin treatment sections is supplied to the filtration device.

8. The liquid circulating system of claim 6, wherein the system is structured such that
at a time of maintenance of the ion exchanger,
liquid is introduced into one of the ion exchange resin treatment sections and washes the ion exchange resin, and liquid that has been used in washing is discharged to a discharge path that is other than the supply pipe, and
liquid is introduced into another of the ion exchange resin treatment sections, and liquid that has passed through the other of the ion exchange resin treatment sections is supplied to the filtration device.
